(19) United States
(12) Patent Application Publication
(10) Pub. No.: US 2014/0233230 A1
(43) Pub. Date: Aug. 21, 2014

(54) LED LUMINARY AND METHOD FOR FABRICATING THE SAME

(71) Applicants: Peng Chen, Shenzhen (CN); Tingming Liu, Shenzhen (CN); Shengmei Zheng, Shenzhen (CN); Chuanpeng Zhong, Shenzhen (CN)

(72) Inventors: Peng Chen, Shenzhen (CN); Tingming Liu, Shenzhen (CN); Shengmei Zheng, Shenzhen (CN); Chuanpeng Zhong, Shenzhen (CN)

(73) Assignee: OSRAM GMBH, Muenchen (DE)

(21) Appl. No.: 14/239,561

(22) PCT Filed: Aug. 24, 2012
(86) PCT No.: PCT/EP2012/066540

§ 371 Date: Apr. 23, 2014

(30) Foreign Application Priority Data
Aug. 31, 2011 (CN) 201110270390.3

(51) Int. Cl. F21K 99/00; F21V 29/00

(52) U.S. Cl. CPC F21K 9/50; F21K 9/30; F21V 29/22; F21K 9/90
USPC 362/235; 362/249.02; 29/832

(57) ABSTRACT

In various embodiments, an LED luminary may include: a plurality of LED light emitting elements; and an installation component for installing the plurality of LED light emitting elements in the LED luminary, wherein the plurality of LED light emitting elements are installed so that the LED light emitting elements are not on the same plane. In various embodiments, a method for fabricating an LED luminary may include: preparing an installation component; and installing a plurality of LED light emitting elements in the LED luminary through the installation component so that the LED light emitting elements are not on the same plane.

### RELATED APPLICATIONS

The present application is a national stage entry according to 35 U.S.C. §371 of PCT application No.: PCT/EP2012/066540 filed on Aug. 24, 2012, which claims priority from Chinese application No.: 201110270390.0 filed on Aug. 31, 2011, and is incorporated herein by reference in its entirety.

### TECHNICAL FIELD

Various embodiments relate to illumination and in particular to an LED luminary and a method for fabricating the same.

### BACKGROUND

At present there are two approaches in which an LED luminary is fabricated.

In a first approach, an LED tube is fabricated of a single row or rows of LEDs, and a luminary cover is a diffuser or filled with a diffusive material to ensure uniform light emission. A structure of such an LED tube is as illustrated in FIG. 1. Drawbacks of the tube are as follows: the luminary cover (diffuser) 11 degrades the luminous efficiency of the LED tube; the single LED chip 12 is bonded on a PCB, and then the entire PCB is bonded or screwed on an aluminum board or a heat sink, so it is cumbersome to fabricate; and the luminary is structurally complicated because the aluminum board 14 and the heat sink 13 of the LED luminary have to be brought into intimate contact through a screw.

In a second approach, an LED luminary is fabricated of a Chip On Board (COB) panel LED module and provided with a transparent cover filled with no diffusive material. A structure of such a luminary is as illustrated in FIG. 2. Drawbacks of the tube lie in that the LED luminary acting as a panel source can not result in the same light distribution as a traditional fluorescent luminary; a package plate of the COB LED has to be bonded or screwed on an aluminum board or a heat sink, so it is cumbersome to fabricate; the luminary is structurally complicated because the aluminum board 14 and the heat sink 13 have to be brought into intimate contact through a screw; and a LED phosphor is of specific soft silicone, and a cover is required to protect the COB LED chip, but the transparent cover 11 makes the PCB or aluminum exposed, thus discouraging the appearance and also degrading the luminous efficiency.

### SUMMARY

In view of the foregoing problems, various embodiments of the disclosure propose an LED luminary and a method for fabricating the LED luminary to address at least one of the drawbacks in the prior art.

According to various embodiments, there is provided an LED luminary including: a plurality of LED light emitting elements; and an installation component for installing the plurality of LED light emitting elements in the LED luminary, wherein the plurality of LED light emitting elements are installed so that the LED light emitting elements are not on the same plane.

According to various embodiments, there is further provided a method for fabricating an LED luminary, including: preparing an installation component; and installing a plurality of LED light emitting elements in the LED luminary through the installation component so that the LED light emitting elements are not on the same plane.

According to various embodiment, there is further provided an illumination device including the foregoing LED luminary.

The LED luminary and the method for fabricating the LED luminary according to the embodiments of the disclosure can achieve more uniform light emission and can further achieve at least one of the following advantageous technical effects: facilitated heat dissipation, an improved luminous efficiency and a lowered cost at which the LED luminary is fabricated.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a diagram illustrating a structure of an LED luminary tube in the prior art;

FIG. 2 is a diagram illustrating another structure of LED luminary tube in the prior art;

FIG. 3 is a schematic diagram illustrating a structure of an LED luminary tube according to an embodiment of the disclosure;

FIG. 4 is an explanatory diagram illustrating a relationship between an axis and a column body;

FIGS. 5A to 5C are schematic diagrams illustrating a construction arrangement of an installation component;

FIG. 6 is a schematic diagram illustrating a structure of an LED luminary tube according to an embodiment of the disclosure;

FIG. 7A is a schematic diagram illustrating installation of a driver in an LED luminary tube according to an embodiment of the disclosure;

FIG. 7B is a exploded schematic diagram illustrating a configuration structure of an installation component, LED chips and silicone, in a case where the installation component in FIG. 7A is used; and

FIG. 8 is a schematic diagram illustrating a method for fabricating an LED luminary tube according to an embodiment of the disclosure.

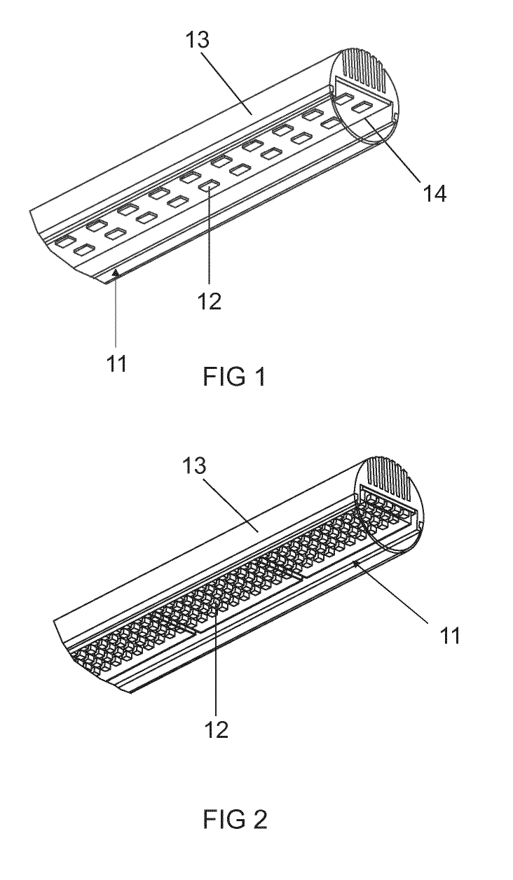

### DETAILED DESCRIPTION OF THE DRAWINGS

The following detailed description refers to the accompanying drawing that show, by way of illustration, specific details and embodiments in which the disclosure may be practiced.

Embodiments of the disclosure will be described below with reference to the drawings in which identical reference numerals represent identical or like components. An element and a feature described in a drawing or an embodiment of the disclosure can be combined with an element and a feature illustrated in one or more other drawings or embodiments. It shall be noted that illustrations and descriptions of components and processes irrelevant to the disclosure and known to those skilled in the art will be omitted in the drawing and the description for the sake of clarity. For example, parts of an LED luminary tube, irrelevant to a technical gist of the disclosure, e.g., a cap, etc., will not be described in details, and only arrangements of components, closely relevant to the disclosure, will be described.

An LED luminary according to an embodiment of the disclosure includes a plurality of LED light emitting elements and an installation component for installing the LED light emitting elements in the LED luminary, where the plurality of LED light emitting elements are installed so that these LED light emitting elements are not on the same plane.

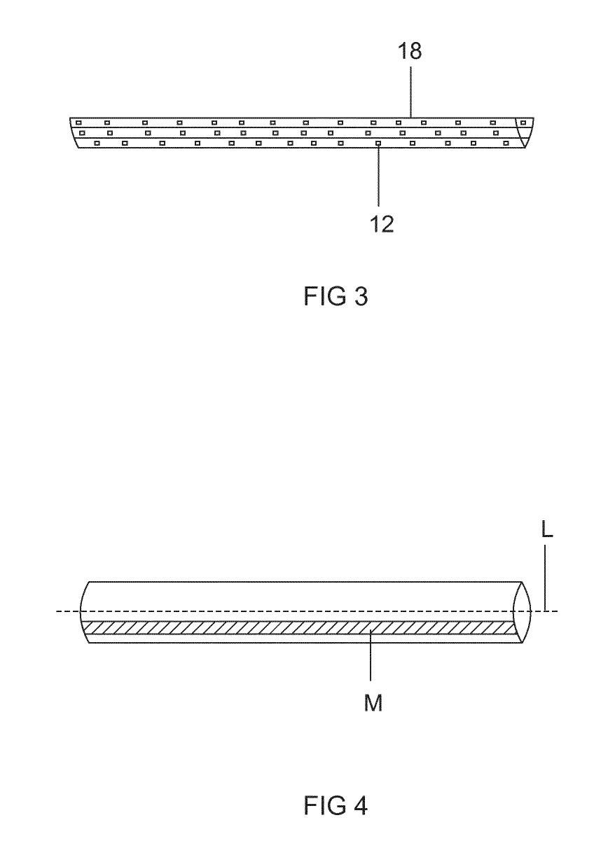

FIG. 3 is a schematic diagram illustrating an internal structure of a specific example of the LED luminary according to the embodiment of the disclosure, and in this example, the LED luminary is embodied as an LED luminary tube. For the sake of clarity, no other part of the LED luminary tube, irrelevant to the disclosure, is illustrated in FIG. 3. As illustrated in FIG. 3, the LED luminary tube according to the embodiment of the disclosure includes an installation component 18 and a plurality of LED chips 12 equivalent to LED light emitting elements in the LED luminary tube. The LED chips are installed in the LED luminary tube through the installation component 18, and an arrangement of the LED chips on the installation component 18 will not be limited to the linear arrangement illustrated in FIG. 3 but can be in arrays, in a variety of polygonal shapes, etc., and the LED chips can be arranged in any appropriate pattern as needed for practical illumination, and the disclosure will be not limited in this respect. Furthermore the disclosure will be described taking an LED luminary tube as an example only for the sake of convenience, and a contour shape of the LED luminary tube will not be limited to a tubular shape but can be any other shape so long as the installation component can be housed therein and the LED chips will not emit light on the same plane.

A specific example of the installation component 18 illustrated in FIG. 3 will be described below in details. As illustrated in FIG. 3, the installation component runs along the direction of an axis of the LED luminary tube (not illustrated in FIG. 3). As represented with a dotted line L in FIG. 4, the axis L is an imaginary line running along the center of a cylinder (or another cube, e.g., prism, etc.) of the LED luminary tube. Hatching below the axis L illustrated in FIG. 4 represents a part M on the cylinder, referred to as an arc curved surface M which is an arc curved surface with the axis L being an axis thereof.

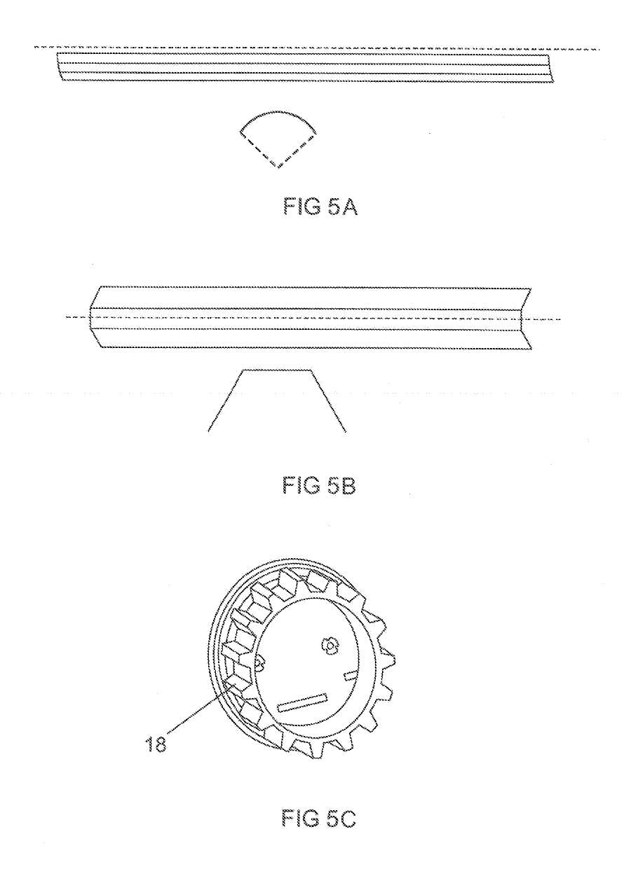

In an embodiment, the installation component includes at least two arc curved surfaces with the axis of the LED luminary tube being an axis thereof. In the example illustrated in FIG. 3, the installation component 18 includes six consecutive arc curved surfaces with the axis of the LED luminary tube being an axis thereof. These consecutive arc curved surfaces constitute a cylinder, a semi-cylinder, a one-fourth cylinder, etc., with the axis of the LED luminary tube being an axis thereof. In the example illustrated in FIG. 3, the installation component 18 is a semicylinder. FIG. 5A illustrates a scenario with the installation component being a one-fourth cylinder.

Alternatively the installation component can include at least two planes which run in the direction parallel to the direction of the axis of the LED luminary tube but are not on the same plane and which constitute a prism, e.g., a semi-prism, a one-fourth prism, etc., with the axis of the LED luminary tube being an axis thereof. FIG. 5B illustrates a scenario with the installation component constituting a semi-prism.

In an alternative embodiment, the installation component can be embodied as a toothed polyhedron with the axis of the LED luminary tube being an axis thereof, as represented with a reference numeral 18 in FIG. 5C. In this case, the polyhedron has a toothed cross section from the perspective of the cross section of the LED luminary tube. Of course, the installation component can be arranged in any appropriate polyhedral shape as needed.

The foregoing curved surfaces or planes constituting the installation component may or may not be consecutive. From the perspective of the cross section of the LED luminary tube, the cylinder can be embodied as a sector with an arbitrary angle larger than 0 degree and smaller than or equal to 360 degrees (a circle if the angle is 360 degrees) or a polygon (or a part thereof). The cross section of the installation component is embodied as a 90-degree sector as illustrated in FIG. 5A or a semihexagon in FIG. 5B. The installation component has been arranged as a cylinder and a prism in the examples listed above but can alternatively be other shapes than a cylinder and a prism, e.g., a column with a cross section of an increasing area, etc., so long as the LED chips can be installed on different planes to emit light at different angles. With the foregoing arrangement, the LED light emitting elements can emit light at various desired angles, so the resulting LED luminary tube can emit light uniformly as a whole with a smooth light emitting surface and a wider range of light emission angles. Furthermore the LED light emitting elements are installed into the LED luminary through the installation component, so the structure of the LED luminary can be simplified and the LED luminary can be fabricated rapidly and conveniently.

In an alternative embodiment, the installation component can be arranged as any combination of various curved surfaces or planes.

The column has been arranged to run along the axis of the LED luminary tube as described above, and for the LED luminary shaped otherwise, the installation component can be shaped similarly to the LED luminary or still as a column and can be positioned centrally or arranged appropriately elsewhere in the LED luminary, and the disclosure will not be limited in this respect. In a specific implementation, the installation component can include a heat sink and an insulating layer arranged in close proximity to each other. The LED chips are installed on the installation component to come into contact with the insulating layer located between the heat sink and the LED chips. This can be done to facilitate heat dissipation of the LED chips and consequently improve the lifetime thereof. As to how the LED chips are arranged on the installation component, single LED chips can be arranged sequentially on the installation component in a predetermined arrangement pattern. In an alternative embodiment, the LED chips can be installed on a PCB circuit board or formed into a Chip On Board (COB) packet, and then the PCB board or the COB packet can be arranged on the installation component. In another alternative embodiment, some of the LED chips can be installed on a PCB circuit board while forming the other LED chips into a Chip On board (COB) packet, and then they can be arranged on the installation component. This is equivalent to division of the LED chips into at least one group so that the LED chips in a part of the groups are formed into a PCB circuit board and the LED chips in another part of the groups are formed into a COB package and then the PCB circuit board or the COB package is installed onto the installation component. Of course, the LED chips can alternatively be arranged on the installation component in any combination of the foregoing arrangements.

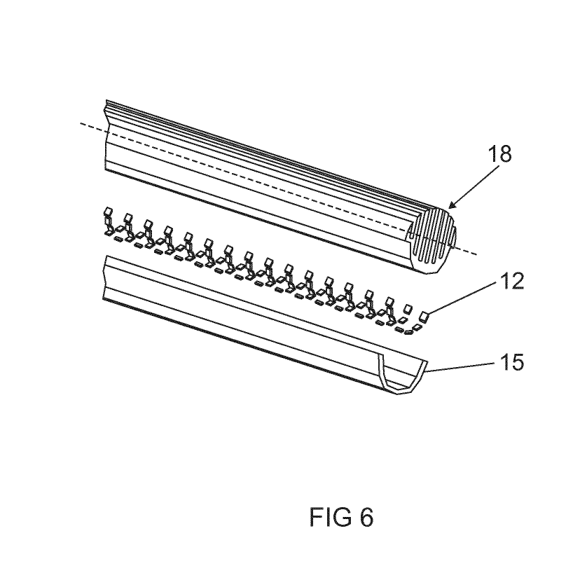

In an alternative embodiment, the installation component can include a heat sink, an aluminum board and an insulating layer arranged in close proximity to each other. As to how the LED chips are arranged on the installation component, they can be arranged similarly in any of the various arrangements as illustrated in the foregoing embodiment where the installation component can include a heat sink and an insulating layer arranged in close proximity to each other, and a repeated description of details thereof will be omitted here. As described above, the installation component can be wholly or partially embodied as a cylinder or prism. In the latter case, the LED chips are installed on the cylinder- or prism-shaped part, as illustrated in FIG. 3, for an enhanced effect of heat dissipation. FIG. 6 illustrates a case where the installation component 18 with no LED chips installed is fin-shaped. However it can be embodied as another structure than a fin to achieve an effect of facilitating heat dissipation.

According to an embodiment of the disclosure, the LED chips are encapsulated with hard silicone filled with a phosphor, as illustrated with a reference numeral 15 in FIG. 6. The LED chips can be well protected by silicone due to hardness thereof without any outer enclosure to thereby reduce the optical loss and consequently improve the luminous efficiency. The disclosure will not be limited in this respect, for example, phosphor can be brought into contact with the LED chips and then the LED chips can be encapsulated by applying hard silicone to the outside thereof. Alternatively the LED chips can be encapsulated conventionally and then a transparent enclosure can be attached to the outside thereof, etc.

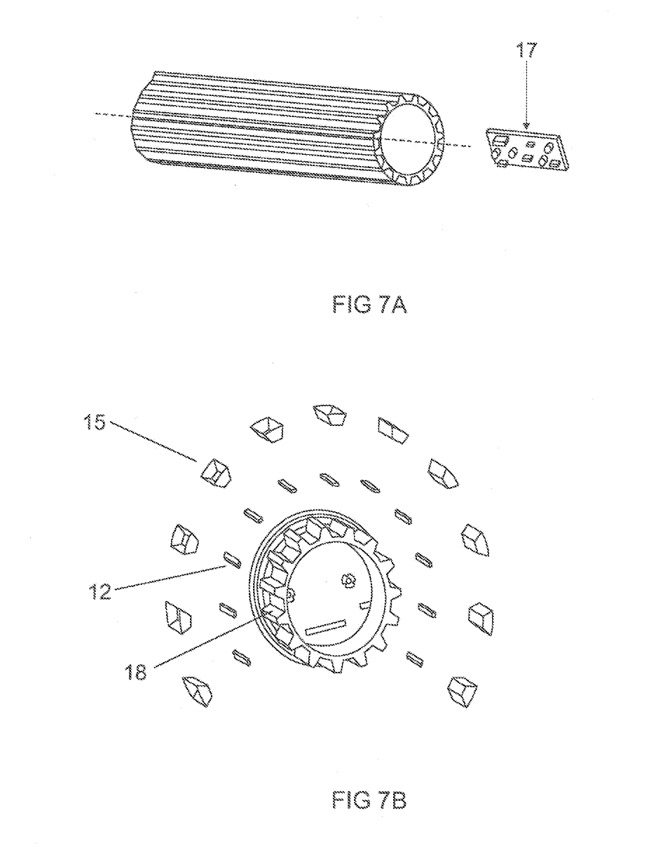

With the structure of the disclosure, a driver housing can be dispensed with because the installation component of the disclosure is embodied with a larger housing space internal to the luminary tube than in the prior art. As illustrated in FIG. 7A, a driver 17 can be housed inside the installation component of the LED chips. In the example of FIG. 7A, the installation component has a toothed cross section. FIG. 7B is an exploded schematic diagram of a configuration structure of an installation component 18, LED chips 12 and silicone 15 filled with a phosphor, in a case where the installation component with a toothed cross section is used.

No luminary enclosure or lead frame for COB LED will be required for the LED luminary tube according to the embodiment of the disclosure, thereby simplifying the structure of the luminary tube and lowering the cost thereof.

Correspondingly an illumination device including the LED luminary according to the embodiment of the disclosure shall also be construed as coming into the claimed scope of the in-vention.

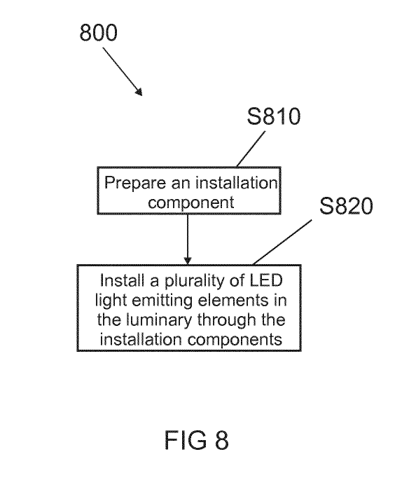

According to an embodiment of the disclosure, there is further provided a method for fabricating an LED luminary, which will be described below with reference to FIG. 8. It shall be noted that a description of fabrication steps known to those skilled in the art and irrelevant to the disclosure will be omitted here. As illustrated in FIG. 8, the method includes preparing an installation component (S810) and then installing a plurality of LED light emitting elements in the luminary through the installation component so that the LED light emitting elements are not on the same plane (S820).

Particularly in the step of preparing the installation component, at least two arc curved surfaces with an axis of the LED luminary tube being an axis thereof are formed. The at least two arc curved surfaces may be consecutive arc curved surfaces constituting a cylinder, a semi-cylinder, a one-fourth cylinder, etc., with the axis of the LED luminary tube being an axis thereof, as illustrated in FIG. 5A. Alternatively, the installation component is embodied as at least two planes which run parallel to the direction of the axis of the LED luminary tube and which are not on the same plane. The at least two planes may be planes abutting against each other and thus constituting a prism, a semi-prism, a one-fourth prism, etc., as illustrated in FIG. 5B. From the perspective of the cross section thereof, the cylinder may be embodied as a sector with an arbitrary angle larger than 0 degree and smaller than or equal to 360 degrees, and the prism may be embodied as an arbitrary polygon or partial polygon.

The installation component has been arranged as a column in the foregoing example but can alternatively be arranged in another shape than a column, e.g., in a toothed shape illustrated in FIG. 5C, etc., to adapt to the shape of the LED luminary. In an alternative embodiment, the installation component can be arranged in any combination of various curved surfaces or planes. The disclosure will not be limited in this respect. With the foregoing arrangement, the LED light emitting elements can emit light at various desired angles, so the resulting LED luminary can emit light uniformly as a whole with a smooth light emitting surface and a wider range of light emission angles. Furthermore the LED light emitting elements are installed into the LED luminary through the installation component, so the structure of the LED luminary can be simplified and the LED luminary can be fabricated rapidly and conveniently. In a specific implementation, the installation component can include a heat sink and an insulating layer arranged in close proximity to each other, and the LED chips are installed on the insulating layer, where the LED chips are equivalent to LED light emitting elements in the LED luminary tube. Single LED chips can be arranged sequentially on the installation component in a predetermined arrangement pattern (linearly, in arrays, in various polygonal shapes, etc.). In an alternative embodiment, the LED chips can be installed on a PCB circuit board or formed into a Chip On Board (COB) packet, and then the PCB circuit board or the COB packet can be arranged on the installation component. In another alternative embodiment, some of the LED chips can be installed on a PCB circuit board while forming the other LED chips into a Chip On board (COB) packet, and then they can be arranged on the installation component. Of course, the LED chips can alternatively be arranged on the installation component in any combination of the foregoing arrangements.

Alternatively the installation component can include a combination of heat sink, an aluminum board and an insulating layer. As to how the LED chips are arranged on the installation component, they can be arranged similarly in any of the various arrangements as illustrated in the foregoing embodiment where the installation component can include a heat sink and an insulating layer arranged in close proximity to each other, and a repeated description of details thereof will be omitted here.

In a specific implementation, a part abutting against the part where the LED chips are installed can be arranged as fin-shaped structure, as illustrated in FIG. 6, for better heat dissipation. Alternatively any other structure facilitating heat dissipation than a fin can also be employed. Furthermore as can be readily understood, the part of the installation component where no LED chips are installed can include both a heat sink or an insulating layer or only a heat sink. The LED chips can be encapsulated with a hard silicone filled with a phosphor following the step S820. The LED chips can be well protected by silicone due to hardness thereof without any outer enclosure equipped in a conventional LED luminary to thereby reduce the optical loss and consequently improve the luminous efficiency. The disclosure will not be limited in this respect, for example, phosphor can be brought into contact with the LED chips and then the LED chips can be encapsulated by applying hard silicone to the outside thereof. Alternatively the LED chips can be encapsulated conventionally and then a transparent enclosure can be attached to the outside thereof. With the method according to the embodiment of the disclosure, a driver for driving the LED chips can be installed inside the LED luminary because the LED luminary fabricated in the method according to the embodiment of the disclosure is provided with a larger space for housing the driver than that in an LED luminary of the prior art.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An LED luminary, comprising:
a plurality of LED light emitting elements; and
an installation component for installing the plurality of LED light emitting elements in the LED luminary,
wherein the plurality of LED light emitting elements are installed so that the LED light emitting elements are not on the same plane.

2. The LED luminary according to claim 1, wherein:
the installation component comprises at least two arc curved surfaces with an axis of the LED luminary being an axis thereof, and the LED light emitting elements are installed on the at least two arc curved surfaces in a predetermined arrangement pattern; and/or
the installation component comprises at least two planes running parallel to the direction of the axis of the LED luminary, and the plurality of LED light emitting elements are installed on the at least two planes in a predetermined arrangement pattern.

3. The LED luminary according to claim 2, wherein the at least two arc curved surfaces constitute a cylinder or partial cylinder with the axis of the LED luminary being an axis thereof and/or the at least two planes constitute a prism or partial prism or a toothed polyhedron or partial toothed polyhedron with the axis of the LED luminary being an axis thereof.

4. The LED luminary according to claim 1, wherein the installation component comprises a heat sink and an insulating layer arranged in close proximity to each other, the insulating layer is located between the heat sink and the plurality of LED light emitting elements, and the plurality of LED light emitting elements come into contact with the insulating layer and fixed on the installation component.

5. The LED luminary according to claim 1, wherein the installation component comprises a heat sink, an aluminum board and an insulating layer arranged sequentially and in close proximity to each other, the aluminum board is located between the heat sink and the insulating layer, and the LED light emitting elements come into contact with the insulating layer and fixed on the installation component.

6. The LED luminary according to claim 1, wherein a part of the installation component where none of the LED light emitting elements is installed is configured to a structure for increasing an area of heat dissipation.

7. The LED luminary according to claim 6, wherein the structure for increasing an area of heat dissipation is a fin-shaped structure.

8. The LED luminary according to claim 1, wherein the LED light emitting elements are encapsulated with hard silicone filled with a phosphor.

9. The LED luminary according to claim 1, wherein the LED light emitting elements are LED chips and divided into at least one group so that the LED light emitting elements in each of at least a part of the groups are installed on a PCB circuit board and/or the LED light emitting elements in each of at least a part of the groups are formed into a Chip On Board COB package.

10. The LED luminary according to claim 1, further comprising a driver for driving the LED light emitting element, wherein the driver is installed inside the LED luminary.

11. An illumination device, comprising an LED luminary,
the LED luminary comprising:
a plurality of LED light emitting elements; and
an installation component for installing the plurality of LED light emitting elements in the LED luminary,
wherein the plurality of LED light emitting elements are installed so that the LED light emitting elements are not on the same plane.

12. A method for fabricating an LED luminary, comprising: preparing an installation component; and
installing a plurality of LED light emitting elements in the LED luminary through the installation component so that the LED light emitting elements are not on the same plane.

13. The method according to claim 12, wherein said preparing the installation component comprises:
preparing the installation component comprising at least two arc curved surfaces with an axis of the LED luminary being an axis thereof and/or at least two planes which run parallel to the direction of the axis of the LED luminary and which are not on the same plane.

14. The method according to claim 13, wherein said preparing the installation component comprises: preparing the least two arc curved surfaces running along the axis of the LED luminary to constitute a cylinder or partial cylinder with the axis of the LED luminary being an axis thereof and/or preparing the at least two planes running parallel to the axis of the LED luminary to constitute a prism or partial prism or a toothed polyhedron or partial toothed polyhedron with the axis of the LED luminary being an axis thereof.

15. The method according to claim 12, wherein the installation component comprises a heat sink and an insulating layer arranged in close proximity to each other, the insulating layer is arranged between the heat sink and the plurality of LED light emitting elements, and the plurality of LED light emitting elements are brought into contact with the insulating layer and fixed on the installation component.

16. The method according to claim 12, wherein the installation component comprises a heat sink, an aluminum board and an insulating layer arranged sequentially and in close proximity to each other, the aluminum board is located between the heat sink and the insulating layer, and the plurality of LED light emitting elements are brought into contact with the insulating layer and fixed on the installation component.

17. The method according to claim 12, wherein a part of the installation component where none of the LED light emitting elements is installed is arranged to a structure for increasing an area of heat dissipation.

18. The method according to claim 17, wherein the structure for increasing an area of heat dissipation is a fin-shaped structure.

19. The method according to claim 12, wherein the LED light emitting elements are encapsulated with hard silicone filled with a phosphor.

20. The method according to claim 12, wherein the LED light emitting elements are LED chips, and said installing the LED chips comprises firstly installing at least a part of the plurality of LED chips on a PCB circuit board and/or firstly forming at least a part of the plurality of LED chips into a Chip On Board COB package, and then installing the PCB circuit board and/or the Chip On Board COB package on the installation component.

21. (canceled)
